(19) United States
(12) Patent Application Publication
(10) Pub. No.: US 2025/0106069 A1
(43) Pub. Date: Mar. 27, 2025

(54) RELAYING APPARATUS, PROGRAM, AND RELAYING METHOD

(71) Applicants: AutoNetworks Technologies, Ltd., Yokkaichi-Shi, Mie (JP); Sumitomo Wiring Systems, Ltd., Yokkaichi-Shi, Mie (JP); Sumitomo Electric Industries, Ltd., Osaka-Shi, Osaka (JP)

(72) Inventor: Tatsuya NAKAJIMA, Yokkaichi-Shi, Mie (JP)

(73) Assignees: AutoNetworks Technologies, Ltd., Yokkaichi-Shi, Mie (JP); Sumitomo Wiring Systems, Ltd., Yokkaichi-Shi, Mie (JP); Sumitomo Electric Industries, Ltd., Osaka-Shi, Osaka (JP)

(21) Appl. No.: 18/730,762

(22) PCT Filed: Jan. 5, 2023
(86) PCT No.: PCT/JP2023/000044

§ 371 Date: Jul. 20, 2024

(30) Foreign Application Priority Data
Jan. 26, 2022 (JP) 2022-010260

(51) Int. Cl. H04L 12/46; B60R 16/023; H04L 67/12

(52) U.S. Cl. CPC H04L 12/46; B60R 16/023; H04L 67/12

(57) ABSTRACT

A relaying apparatus is installed in a vehicle and relays data transmitted and received between a plurality of vehicle-mounted ECUs. The relaying apparatus includes: a plurality of communication units for communicating with each of the vehicle-mounted ECUs; a plurality of control units that one-to-one correspond to the plurality of communication units; and a storage unit that is accessible from each of the plurality of control units. Each of the plurality of control units separately performs an initialization process. When a control unit that has completed the initialization process has acquired relay target data to be relayed via a communication unit corresponding to another control unit that has not completed the initialization process, the control unit stores part of the acquired relay target data in the storage unit by writing in a shared area that is shared with the other control unit that has not completed the initialization process.

### CROSS-REFERENCE TO RELATED APPLICATIONS

This application is the U.S. national stage of PCT/JP2023/000044 filed on Jan. 5, 2023, which claims priority of Japanese Patent Application No. JP 2022-010260 filed on Jan. 26, 2022, the contents of which are incorporated herein.

### TECHNICAL FIELD

The present disclosure relates to a relaying apparatus, a program, and a relaying method.

### BACKGROUND

A vehicle is equipped with a plurality of vehicle-mounted ECUs (Electronic Control Units) for controlling equipment installed in the vehicle, such as a power train system that controls the engine and the like and body-related systems that control equipment such as an air conditioner. Such vehicle-mounted ECUs can be connected by relaying apparatuses and an internal network so as to communicate with each other. A relaying apparatus relays data transmitted and received between the vehicle-mounted ECUs that are connected via the internal network (see, for example, JP 2017-97851A).

The relaying apparatus described in JP 2017-97851A does not consider efficient buffering of data when data is relayed immediately after the relaying apparatus itself starts up, for example.

It is an object of the present disclosure to provide a relaying apparatus and the like that can efficiently store (buffer) data when relaying data that is transmitted and received between vehicle-mounted ECUs.

### SUMMARY

A relaying apparatus according to an aspect of the present disclosure is installed in a vehicle and relays data transmitted and received between a plurality of vehicle-mounted ECUs, the relaying apparatus including: a plurality of communication units for communicating with each of the vehicle-mounted ECUs; a plurality of control units that one-to-one correspond to the plurality of communication units; and a storage unit that is accessible from each of the plurality of control units, wherein each of the plurality of control units separately performs an initialization process, and when a control unit that has completed the initialization process has acquired relay target data to be relayed via a communication unit corresponding to another control unit that has not completed the initialization process, the control unit stores part of the acquired relay target data in the storage unit by writing in a shared area that is shared with the other control unit that has not completed the initialization process.

### Advantageous Effects

According to the aspect described above, it is possible to provide a relaying apparatus and the like that can efficiently store (buffer) data when relaying data that is transmitted and received between vehicle-mounted ECUs.

### BRIEF DESCRIPTION OF DRAWINGS

FIG. 1 is a schematic diagram depicting the configuration of a vehicle-mounted system including a relaying apparatus according to a first embodiment.

FIG. 2 is a block diagram depicting an example physical configuration of the relaying apparatus.

FIG. 3 is a diagram illustrating examples of the initialization processes performed by a plurality of control units.

FIG. 4 is a diagram (a correspondence table) useful in explaining the correspondence between a plurality of control units and internal communication units.

FIG. 5 is a diagram (relaying route table) illustrating relaying route information.

FIG. 6 is a diagram (logical configuration diagram) illustrating a relaying process of relay target data in a relaying apparatus.

FIG. 7 is a flowchart depicting the processing of a control unit of the relaying apparatus.

FIG. 8 is a flowchart depicting the processing of a control unit of a relaying apparatus according to a second embodiment (storage of most recent value).

FIG. 9 is a diagram illustrating initialization processes by a plurality of control units according to a third embodiment (initialization completion imminent).

FIG. 10 is a flowchart depicting the processing of a control unit of the relaying apparatus.

FIG. 11 is a flowchart depicting the processing of a control unit of the relaying apparatus according to a fourth embodiment (buffering mode selection).

### DETAILED DESCRIPTION OF PREFERRED EMBODIMENTS

Several embodiments of the present disclosure will first be listed and described. Note that the embodiments described below may also be freely combined, at least in part.

A relaying apparatus according to an aspect of the present disclosure is installed in a vehicle and relays data transmitted and received between a plurality of vehicle-mounted ECUs, the relaying apparatus including: a plurality of communication units for communicating with each of the vehicle-mounted ECUs; a plurality of control units that one-to-one correspond to the plurality of communication units; and a storage unit that is accessible from each of the plurality of control units, wherein each of the plurality of control units separately performs an initialization process, and when a control unit that has completed the initialization process has acquired relay target data to be relayed via a communication unit corresponding to another control unit that has not completed the initialization process, the control unit stores part of the acquired relay target data in the storage unit by writing in a shared area that is shared with the other control unit that has not completed the initialization process.

According to this aspect, the relaying apparatus starts up by each of the plurality of control units included in the relaying apparatus separately performing an initialization process and transitions via these initialization processes into a state where normal operations, such as a relaying process, are performed. These initialization processes by the plurality of control units may be performed for example in a predetermined order, that is, the plurality of control units may sequentially perform the initialization process. After completing the initialization process, the plurality of control units perform, according to the control program executed by each control unit, a relaying process (or “normal operation”) of data acquired (received) via the communication unit that that control unit controls (that is, its own communication unit). At this time, when a first control unit that has completed the initialization process and started a relaying process (that is, a normal operation) passes acquired relay target data to another control unit which corresponds to a communication unit that is the relay destination, the first control unit writes (buffers) the relay target data into a shared area (or storage unit) that is shared with the other control unit. At this time, it is assumed that the other control unit is yet to complete the initialization process and has not started the relaying process (that is, normal operations). Even in this case, since the first control unit writes (buffers) part of the relay target data out of the acquired relay target data into the shared area (the storage unit), it is possible to prevent the shared area (storage unit) from being used up or overflowing. Even if the first control unit has acquired a plurality of relay target data, by buffering only part of the relay target data out of the plurality of relay target data, it is possible to buffer (store) only part of the relay target data, which is a smaller amount of data than the total amount of relay target data that has been acquired (received), in the storage unit. As a result, even if each of the plurality of control units sequentially performs the initialization process and the individual control units start the relaying process (or “normal operations”) at different timing (that is, with different relaying process starting points), it will still be possible to limit the amount of relay target data that is written into the shared area (storage unit) shared with the other control unit. Accordingly, it is possible to prevent the shared area (storage unit) from running out of storage space (a so-called “buffer overflow”). In other words, although there is a time difference between the relaying process starting points of the respective control units, the data received during the period corresponding to this time difference is not buffered in its entirety and by buffering only part of the received data based, for example, on a buffering mode set in advance, it is possible to prevent problems such as the shared area (storage unit) becoming insufficient. By doing so, it is possible to reduce the storage capacity of the storage unit installed in the relaying apparatus.

In the relaying apparatus according to an aspect of the present disclosure, out of the acquired relay target data, the control unit that has completed the initialization process writes relay target data with a predetermined priority or higher into the shared area.

According to this aspect, the relay target data includes a plurality of types of relay target data, and the priority of relay target data is determined in advance according to such types. As one example, the control unit that has completed the initialization process writes only types of relay target data whose priority is higher than or equal to a predetermined value into the shared area, which makes it possible to store (buffer) a smaller amount of data than the total amount of acquired (received) relay target data into the storage unit.

In the relaying apparatus according to one aspect of the present disclosure, the relay target data is CAN messages, and the control unit that has completed the initialization process specifies the priority of the relay target data in keeping with a CAN-ID included in the relay target data.

According to this aspect, the relay target data is CAN messages, and the priority of such CAN messages is specified using, for example, the CAN-IDs included in the CAN messages. The CAN messages include CAN-FD messages. During communication using the CAN protocol, the smaller the CAN-ID value, the higher the transmission priority during arbitration (mediation of communication). By specifying the priority based on such CAN-IDs, it is possible, in accordance with communication arbitration in CAN protocol, to store (buffer) comparatively important CAN messages in the storage unit. Accordingly, by assigning (setting) a flag value indicating the priority so that a CAN-ID with a value that is smaller than or equal to a predetermined value is given a priority of 1 (1=“buffered”) and a CAN-ID with a value that is larger than the predetermined value is given a priority of 0 (0=“not buffered”), it is possible to set the priority of the relay target data (CAN messages). The setting of priorities is not limited to two levels indicating whether data is to be buffered, and may be a setting of a plurality of levels composed of three or more levels. Alternatively, the priority may be set using the value of the CAN-ID itself. In this case, the smaller the value of the CAN-ID, the higher the priority for buffering. Note that in the present embodiment, the data transmitted and received between the vehicle-mounted ECUs is not limited to CAN messages, and may be IP packets that conform to TCP/IP protocol. In the case of IP packets, priority, that is, a flag value indicating whether to buffer data (where high means “buffered” and “low” means “not buffered), may be determined according to the port number (TCP port number or UDP port number) defined in the TCP/IP protocol.

In the relaying apparatus according to one aspect of the present disclosure, when the acquired plurality of pieces of relay target data include relay target data of a same type, the control unit that has completed the initialization process writes most recent relay target data, out of the relay target data of the same type, into the shared area.

According to this aspect, by writing the most recent relay target data out of a plurality of relay target data of the same type into the shared area, it is possible to store (buffer) the most recent values for each type of relay target data in the storage unit.

In the relaying apparatus according to one aspect of the present disclosure, the relay target data is CAN messages, and the control unit that has completed the initialization process determines whether relay target data is the same type based on a CAN-ID included in each relay target data.

According to this aspect, when the control unit that has completed the initialization process has acquired relay target data that is a CAN message, the control unit determines whether relay target data (CAN messages) are of the same type based on the CAN-IDs included in the CAN messages, which means that determination of type can be made efficiently. In the case of IP packets, the determination of whether the IP packets that correspond to the relay target data are the same type may be based for example, on the port number defined by TCP/IP protocol (a TCP port number or UDP port number) or a combination of a port number and a transmission source address (or simply “source address”).

In the relaying apparatus according to one aspect of the present disclosure, the control unit that has completed the initialization process writes relay target data, which is acquired during a buffering period specified using an initialization process starting point of the other control unit that has not completed the initialization process, into the shared area.

According to this aspect, starting points (or start times) of initialization, initialization times required for initialization, and relaying process starting points (or relaying process starting times) calculated by adding the initialization time to the starting points are stored for each control unit in the storage unit for example as initialization scheduling information. A first control unit that has completed the initialization process refers to this initialization scheduling information based on its own relaying process starting point, specifies the relaying process starting point of another control unit that has not completed the initialization process, and writes relay target data acquired during a buffering period whose end point is the relaying process starting point of the other control unit into the storage unit. This buffering period is set as a shorter period than a period from the relaying process starting point of the control unit that has completed the initialization process to the relaying process starting point of the other control unit that has not completed the initialization process. By doing so, even if the period due to the time difference between the relaying process starting point of the first control unit and the relaying process starting point of the other control unit is longer than the buffering period, it will be possible to write, into the shared area, only relay target data acquired (received) during a buffering period which has been specified by back-calculation with the relaying process starting point of the other control unit as a reference (end point). As a result, the most recent and relatively new relay target data can be efficiently stored (buffered) based on the relaying process starting point of the other control unit.

In the relaying apparatus according to one aspect of the present disclosure, the buffering period is determined based on a transmission cycle of the relay target data.

According to this aspect, the buffering period is determined based on the transmission cycle of the relay target data, and as one example is set in advance to be longer than or equal to the transmission cycle. When the relay target data includes a plurality of types of relay target data, the buffering period may be set longer than or equal to the longest transmission cycle out of the transmission cycles of the respective types of relay target data. By setting a minimum value of the buffering period in this way, it is possible, when the relay target data includes a plurality of types of relay target data, to acquire and store each type of relay target data at least once. Alternatively, the buffering period may be set shorter than or equal to the sum of the transmission cycles of each type of relay target data. By setting a maximum value for the buffering period in this way, it is possible to prevent the buffering period from becoming excessively long and thereby prevent the total amount of the relay target data to be stored (the relay target data to be buffered) from increasing excessively.

The relaying apparatus according to one aspect of the present disclosure is provided with a plurality of buffering modes for identifying the part of the acquired relay target data that is to be written into the shared area, and the control unit that has completed the initialization process writes the part of the acquired relay target data into the shared area according to one or more buffering modes selected out of the plurality of buffering modes.

According to this aspect, the relay device is provided with a plurality of buffering modes for specifying the part of the acquired relay target data to be written when writing the relay target data into the shared area. The plurality of buffering modes include, for example, “priority mode”, “most recent value mode”, and “initialization completion imminent mode”. When priority mode is selected, out of the acquired relay target data, the control unit that has completed the initialization process writes relay target data with a predetermined priority or higher into the shared area. When most recent value mode is selected and the acquired relay target data includes a plurality of relay target data of the same type (for example, the same CANID), the control unit that has completed the initialization process writes the most recent relay target data out of the plurality of relay target data of the same type into the shared area. When initialization completion imminent mode is selected, the control unit that has completed the initialization process writes the acquired relay target data into the shared area during a buffering period specified from the relaying process starting point of the other control unit that has not completed the initialization process. When two or more buffering modes have been selected, the control unit that has completed the initialization process writes part of the acquired relay target data according to a combination of the two or more selected buffering modes into the shared area. By making a setting so that any single buffering mode out of the plurality of buffering modes, or a combination of two or more buffering modes is selectable, it becomes possible to use an appropriate buffering mode or modes according to factors such as the model and type of vehicle in which the relaying apparatus is installed and the running state of the vehicle, which makes it possible to improve the availability of the relaying apparatus.

A program according to an aspect of the present disclosure is a program for causing a computer, which is installed in a vehicle, relays data transmitted and received between a plurality of vehicle-mounted ECUs, and is equipped with a plurality of communication units for communicating with each of the vehicle-mounted ECUs, a plurality of control units that one-to-one correspond to the plurality of communication units, a storage unit that is accessible from each of the plurality of control units, to execute processing including: each of the plurality of control units separately performing an initialization process; and when a control unit that has completed the initialization process has acquired relay target data to be relayed via a communication unit corresponding to another control unit that has not completed the initialization process, the control unit storing part of the acquired relay target data in the storage unit by writing in a shared area that is shared with the other control unit that has not completed the initialization process.

According to this aspect, it is possible to provide a program that causes a computer to function as a relaying apparatus that efficiently stores (buffers) data when relaying data transmitted and received between vehicle-mounted ECUs.

A relaying method according to an aspect of the present disclosure is a relaying method for causing a computer, which is installed in a vehicle, relays data transmitted and received between a plurality of vehicle-mounted ECUs, and is equipped with a plurality of communication units for communicating with each of the vehicle-mounted ECUs, a plurality of control units that one-to-one correspond to the plurality of communication units, a storage unit that is accessible from each of the plurality of control units, to execute processing including: each of the plurality of control units separately performing an initialization process; and when a control unit that has completed the initialization process has acquired relay target data to be relayed via a communication unit corresponding to another control unit that has not completed the initialization process, the control unit storing part of the acquired relay target data in the storage unit by writing in a shared area that is shared with the other control unit that has not completed the initialization process.

According to this aspect, it is possible to provide an information processing method that causes a computer to function as a relaying apparatus that efficiently stores (buffers) data when relaying data transmitted and received between vehicle-mounted ECUs.

Preferred embodiments of the present disclosure will now be described in detail with reference to the attached drawings. A relaying apparatus 2 according to an embodiment of the present disclosure will now be described in detail with reference to the attached drawings. Note that the present disclosure is not limited to the illustrated examples and is instead indicated by the range of the patent claims and intended to include all possible changes within the meaning and scope of the patent claims and their equivalents.

### First Embodiment

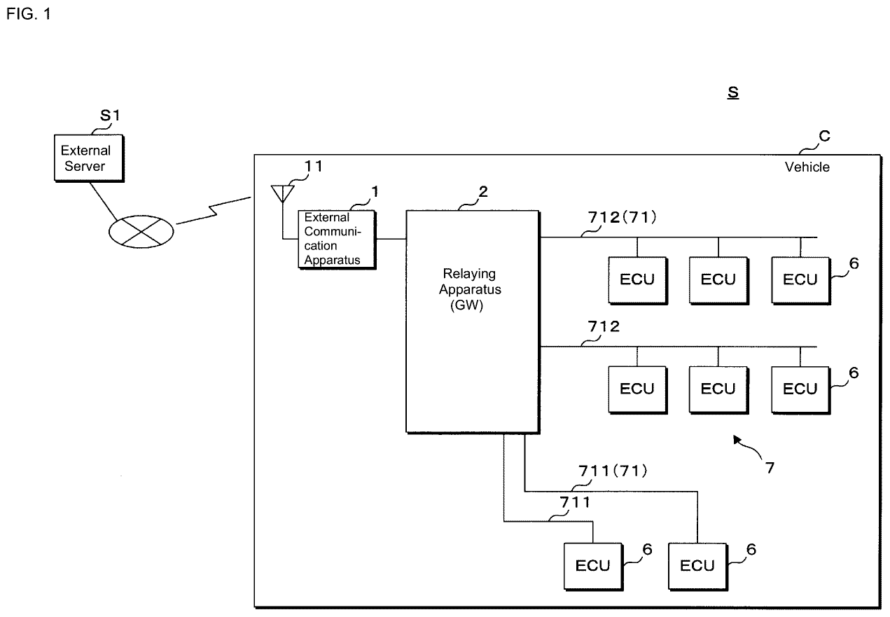

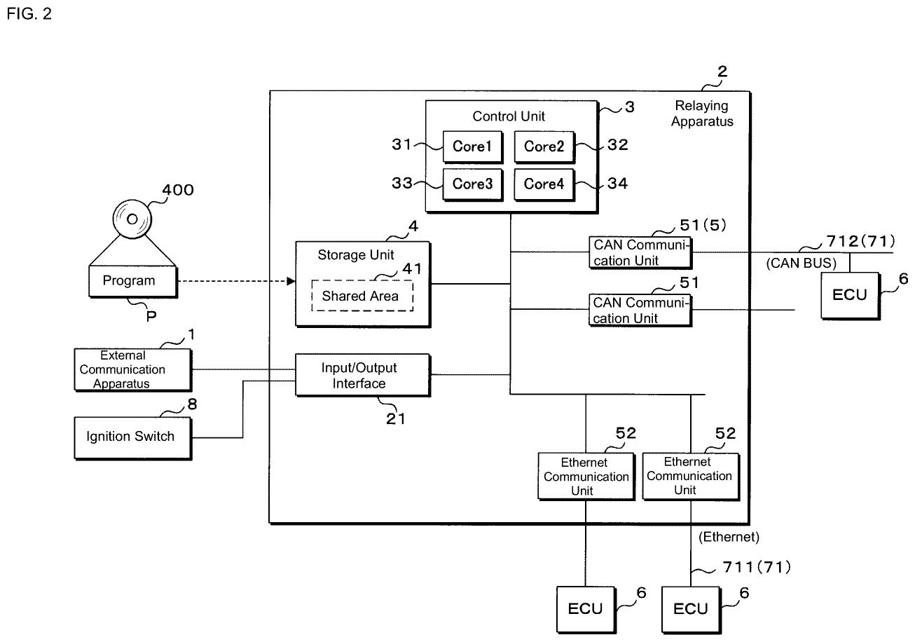

A first embodiment will now be described with reference to the attached drawings. FIG. 1 is a schematic diagram depicting the configuration of a vehicle-mounted system including a relaying apparatus 2 according to the first embodiment. FIG. 2 is a block diagram depicting an example physical configuration of the relaying apparatus 2. The vehicle-mounted system S is configured with the relaying apparatus 2 installed in a vehicle C as a main device. The relaying apparatus 2 is connected so as to communicate with a plurality of vehicle-mounted ECUs 6 installed in the vehicle C. The relaying apparatus 2 receives transmission data (or “communication data”) transmitted from each of the plurality of vehicle-mounted ECUs 6, and performs a relaying process on the transmission data based on header information including a message ID or a transmission destination address included in the transmission data. The relaying apparatus 2 may also be connected so as to communicate via an external communication apparatus 1 to an external server S1 connected to an external network, such as the Internet. The relaying apparatus 2 may also perform a relaying process of transmission data (or “communication data”) transmitted and received between the external server S1 and the vehicle-mounted ECUs 6 installed in the vehicle C.

The vehicle C is equipped with the external communication apparatus 1, the relaying apparatus 2, and the plurality of vehicle-mounted ECUs 6 for controlling various vehicle-mounted devices (such as actuators and sensors). The external communication apparatus 1 and the relaying apparatus 2 are connected for communication purposes by a harness for example, such as a serial cable. The relaying apparatus 2 and the vehicle-mounted ECU 6 are connected for communication purposes by a vehicle-mounted network 7 that conforms to a communication protocol such as CAN (Control Area Network), CAN-FD, or Ethernet (registered trademark).

The external communication apparatus 1 includes an external communication unit (not illustrated) and an input/output interface (not illustrated) for communicating with the relaying apparatus 2. The external communication unit is a communication apparatus for wireless communication using a mobile communication protocol such as LTE, 4G, 5G, or Wi-Fi, and transmits and receives data to and from the external server S1 via an antenna 11 connected to the external communication unit. Communication between the external communication apparatus 1 and the external server S1 is performed, for example, via public lines or an external network such as the Internet.

The relaying apparatus 2 functions as a CAN gateway, an Ethernet switch (a Layer 2 switch or Layer 3 switch), or the like, and further includes a function of performing protocol conversion between different protocols, such as between CAN protocol and TCP/IP protocol. The relaying apparatus 2 may be a PLB (Power Lan Box) which, in addition to the relaying of communication, also functions as a power distributing apparatus that distributes and relays power outputted from a power supply device, such as a secondary battery, to supply power to vehicle-mounted devices, such as actuators, that are connected thereto (that is, to the relaying apparatus 2). Alternatively, the relaying apparatus 2 may be configured as a functional part of a body ECU that controls the vehicle C as a whole. As another alternative, the relaying apparatus 2 may be an integrated ECU that is composed of a central control apparatus, such as a vehicle computer, and performs overall control of the vehicle C.

The relaying apparatus 2 includes a control unit 3, a storage unit 4, an internal communication unit 5, and an input/output interface 21. The control unit 3 is composed of a CPU (Central Processing Unit), an MPU (Micro Processing Unit), or the like, and is designed to perform various control processing, arithmetical processing, and the like by reading and executing a control program P (or program product) and data stored in advance in the storage unit 4.

The control unit 3 includes a plurality of control units 3 including a first control unit 31, a second control unit 32, a third control unit 33, and a fourth control unit 34. As one example, when the control unit 3 is a multi-core CPU composed of four cores (that is, a “quad-core” configuration), each of the first control unit 31, the second control unit 32, the third control unit 33, and the fourth control unit 34 corresponds to a core. The control unit 3 is not limited to being a multi-core CPU, and may be a multi-CPU including a plurality of single-core CPUs or may include two dual-core CPUs. This configuration where the control unit 3 is composed of four cores (individual control units 3) including the first control unit 31, the second control unit 32, the third control unit 33, and the fourth control unit 34 is merely one example, and the control unit 3 may have an octacore configuration, for example. Although described in detail later, each of the first control unit 31, the second control unit 32, the third control unit 33, and the fourth control unit 34 perform an initialization process at different timing. There is also correspondence between each of the first control unit 31, the second control unit 32, the third control unit 33, and the fourth control unit 34 and internal communication units.

The storage unit 4 is composed of a volatile memory element, such as a RAM (Random Access Memory), or a nonvolatile memory element such as a ROM (Read Only Memory), an EEPROM (Electrically Erasable Programmable ROM), or flash memory, and stores in advance a control program P and data that is referred to during processing. This control program P (or program product) stored in the storage unit 4 may be the result of storing a control program P (or program product) that has been read from a recording medium 400 that is readable by the relaying apparatus 2. The control program P may include individual control programs P corresponding to the first control unit 31, the second control unit 32, the third control unit 33, and the fourth control unit 34, respectively.

The storage unit 4 can be accessed from each of the plurality of cores (that is, the first control unit 31, the second control unit 32, the third control unit 33, and the fourth control unit 34) that constitute the control unit 3, and includes a shared area 41 used as a shared memory by the control unit 31, the second control unit 32, the third control unit 33, and the fourth control unit 34. The shared area 41 may be set in an area defined by a physical address or a logical address in the storage unit 4. Shared areas 41 may be set individually for combinations of the first control unit 31, the second control unit 32, the third control unit 33, and the fourth control unit 34. That is, the shared area 41 may include a shared area 41 for the first control unit 31 and the second control unit 32, a shared area 41 for the first control unit 31 and the third control unit 33, a shared area 41 for the first control unit 31 and the fourth control unit 34, a shared area 41 for the second control unit 32 and the third control unit 33, a shared area 41 for the second control unit 32 and the fourth control unit 34, and a shared area 41 for the third control unit 33 and the fourth control unit 34.

The internal communication unit 5 is an input/output interface that uses a communication protocol such as CAN (Control Area Network), CAN-FD (CAN with a Flexible Data rate), or Ethernet (TCP/IP). The internal communication unit 5 includes CAN communication units 51 constituted of CAN transceivers and Ethernet communication units 52 constituted of Ethernet PHY units, and functions as a communication unit that corresponds to a physical layer for communication between the relaying apparatus 2 and the vehicle-mounted ECUs 6. The relaying apparatus 2 may be configured such that the number of internal communication units 5 and the number of cores etc. that constitute the control unit 3 are the same.

The plurality of internal communication units 5 are provided, with the respective internal communication units 5 being connected to the respective communication lines 71 (the Ethernet cable 711 and the CAN bus 712), which is to say, the respective buses, that constitute the vehicle-mounted network 7. By providing a plurality of internal communication units 5 in this way, the vehicle-mounted network 7 can be divided into a plurality of buses or segments, and each vehicle-mounted ECU 6 can be connected to a bus and the like according to the functions of that vehicle-mounted ECU 6. The control unit 3 of the relaying apparatus 2 communicates with vehicle-mounted ECUs 6 connected to the vehicle-mounted network 7 via these internal communication units 5.

In the same way as the input/output interface of the external communication apparatus 1, the input/output interface 21 is a communication interface for serial communication, for example. The relaying apparatus 2 is connected for communication purposes via the input/output interface 21 to the external communication apparatus 1 and an ignition switch 8 that starts and stops the vehicle C. The connections between the external communication apparatus 1 and ignition switch 8 and the relaying apparatus 2 are not limited to connections via an input/output interface and may be connections via an internal communication unit 5.

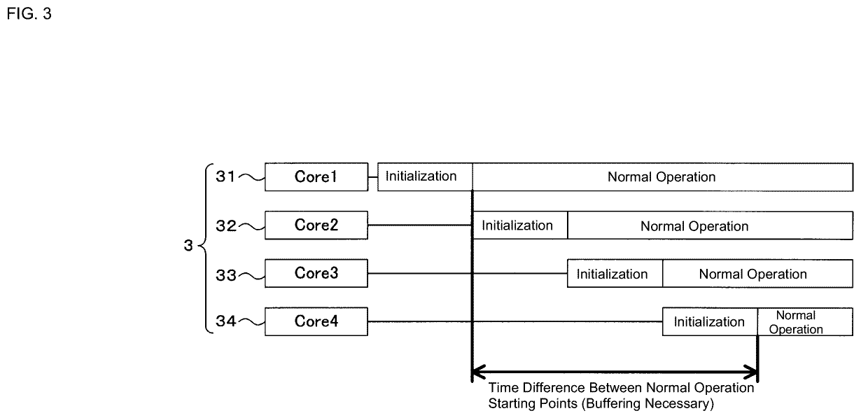

FIG. 3 is a diagram illustrating examples of the initialization processes performed by the plurality of control units 3. As one example, the control unit 3 that has a multicore configuration (in this embodiment, a quad-core configuration) includes the first control unit 31, the second control unit 32, the third control unit 33, and the fourth control unit 34 that correspond to each core.

Due to the first control unit 31, the second control unit 32, the third control unit 33, and the fourth control unit 34 sequentially starting the initialization process, a normal operation starting point (or “initialization completion point”) at which normal operations such as the relaying process start will differ between control units. As one example, the order of these initialization processes may be defined in a correspondence table described later.

In the present embodiment, the first control unit 31, the second control unit 32, the third control unit 33, and the fourth control unit 34 each start the initialization process in that order. The first control unit 31 performs the initialization process first, and after initialization of the first control unit 31 is complete, the second control unit 32 starts the initialization process. After initialization of the second control unit 32 is complete, the third control unit 33 starts the initialization process. After initialization of the third control unit 33 is complete, the fourth control unit 34 starts the initialization process.

In this way, the first control unit 31, the second control unit 32, the third control unit 33, and the fourth control unit 34 each perform the initialization process sequentially, so that a time difference is produced in the normal operation starting points between the first control unit 31 and the fourth control unit 34, for example. Due to this time difference in the normal operation starting points, from the normal operation starting point of the first control unit 31 to the normal operation starting point of the fourth control unit 34, it is not possible to perform a direct relaying process from the first control unit 31 to the fourth control unit 34. For this reason, out of transmission data that has been received (acquired), the first control unit 31 stores (buffers) any relay target data which is to be relayed via an internal communication unit 5 controlled by the fourth control unit 34 in the shared area 41 for the first control unit 31 and the fourth control unit 34. However, if all relay target data received during a period from the normal operation starting point of the first control unit 31 to the normal operation starting point of the fourth control unit 34 were to be buffered in this shared area 41, there would be concern that the capacity (free space) in that shared area 41 would be insufficient. In contrast, by having the first control unit 31 buffer only some relay target data out of all of the received relay target data in that shared area 41, tightness in the storage capacity (free space) of the shared areas 41 is avoided.

The first control unit 31 performs the same buffering process as the buffering process for the fourth control unit 34 described above on the second control unit 32 and the third control unit 33 which, in the same way as the fourth control unit 34, perform the initialization process after the first control unit 31 (that is, after the first control unit 32 completes the initialization process). The second control unit 32 also performs the same buffering process as the first control unit 31 on the third control unit 33 and the fourth control unit 34 that perform the initialization process after the second control unit 32. The third control unit 33 also performs the same buffering process as the first control unit 31 on the fourth control unit 34 that performs the initialization process after the third control unit 33.

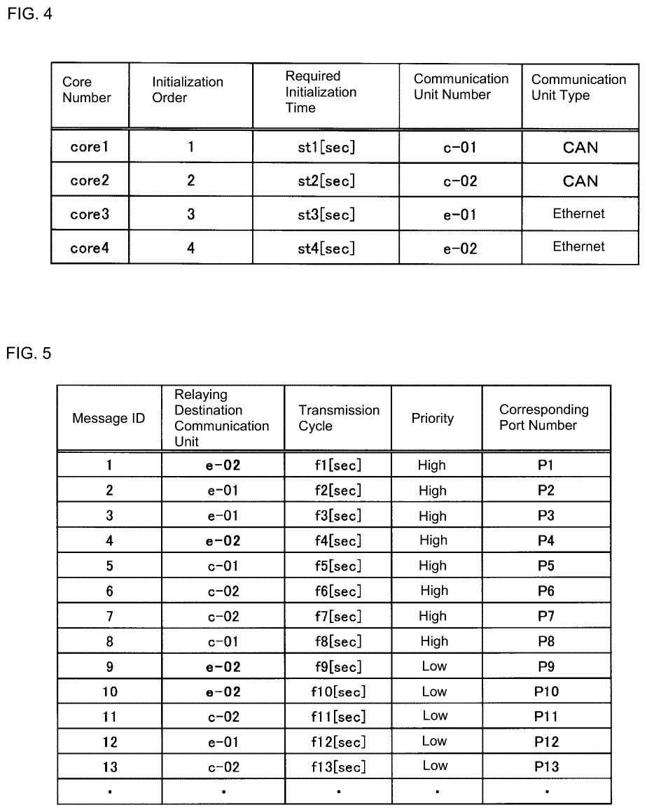

FIG. 4 is a diagram (a correspondence table) illustrating the correspondence between the plurality of control units 3 and the internal communication units 5. Information (or “correspondence information”) indicating the correspondence between the first control unit 31, the second control unit 32, the third control unit 33, and the fourth control unit 34 that constitute the control unit 3 and the internal communication units 5 is stored for example in table format (as a correspondence table) in the storage unit 4. As example fields, the correspondence table includes core number, initialization order, required initialization time, communication unit number, and communication unit type fields. The core number field stores device numbers that uniquely indicate each

of the first control unit 31, the second control unit 32, the third control unit 33, and the fourth control unit 34 that constitute the control unit 3. In the present embodiment, core numbers indicating each of the first control unit 31 (“Core1”), the second control unit 32 (“Core2”), the third control unit 33 (“Core3”), and the fourth control unit 34 (“Core4”) are stored. When the control unit 3 is configured using multiple CPUs, CPU numbers may be stored in this field.

The initialization order field indicates the order in which each of the first control unit 31, the second control unit 32, the third control unit 33, and the fourth control unit 34 that constitute the control unit 3 start the initialization process. In the present embodiment, the initialization process is performed by the first control unit 31, the second control unit 32, the third control unit 33, and the fourth control unit 34 in that order. By referring to this initialization order, each control unit 3 can identify other control units 3 that will perform the initialization process later than itself.

The required initialization time field stores the time required for the initialization process of each of the first control unit 31, the second control unit 32, the third control unit 33, and the fourth control unit 34. By referring to the required initialization time, each control unit 3 can calculate the time at which another control unit 3 that performs the initialization process later than itself will complete the initialization process. In this way, by including the initialization order and required initialization time fields, the correspondence table includes initialization scheduling information.

The communication unit number field stores the device numbers of the internal communication units 5 that respectively correspond to the first control unit 31, the second control unit 32, the third control unit 33, and the fourth control unit 34. Based on this correspondence, each control unit 3 transmits and receives transmission data via the corresponding internal communication unit 5. The communication unit type field stores the protocol type of the internal communication unit 5 corresponding to each of the first control unit 31, the second control unit 32, the third control unit 33, and the fourth control unit 34. The detailed correspondence between the respective control units 3 and the internal communication units 5 will be described later.

FIG. 5 is a diagram (a relaying route table) illustrating relaying route information. The relaying route information used when the relaying apparatus 2 performs a relaying process on transmission data received from a vehicle-mounted ECU 6 or the external server S1 is stored in the storage unit 4 for example in table format (as a “relaying route table”). Example fields in the relaying route table include message ID, relaying destination communication unit, transmission cycle, priority, and corresponding port number fields.

The message ID field stores a communication data identifier for classifying or identifying the transmission data, for example, a message ID or the like included in a CAN message. The relaying destination communication unit field stores the communication unit number of the internal communication unit 5 that is the relaying destination of the transmission data with the message ID stored in the same record. The communication unit number is a value that is defined (stored) in the correspondence table. By specifying a communication unit number, it is possible to specify the control unit 3 corresponding to that communication unit number, that is, to specify one of the first control unit 31, the second control unit 32, the third control unit 33, and the fourth control unit 34. By including the relaying destination communication unit field, the relaying route table includes route information (or “routing information”) used when the relaying apparatus 2 performs a relaying process.

The transmission cycle field stores the transmission cycle of the transmission data with the message ID stored in the same record. The priority field stores a value indicating the priority of the transmission data with the message ID stored in the same record. The priority is determined based on the message ID. For message IDs in CAN protocol, the smaller the numerical value, the higher the priority given in arbitration (that is, mediation performed during communication). In the present embodiment, message IDs that are below a predetermined value are set as high priority, and message IDs that are greater than or equal to the predetermined value are set as low priority.

If the transmission data with the message ID stored in the same record is a CAN message, the corresponding port number field will store a port number (a TCP port or UDP port number) that is included in the IP packet when protocol conversion is performed to convert the CAN message to an IP packet. By including the corresponding port number field, the relaying route table includes protocol conversion information which will be used for protocol conversion between a CAN message and an IP packet when the relaying apparatus 2 performs a relaying process.

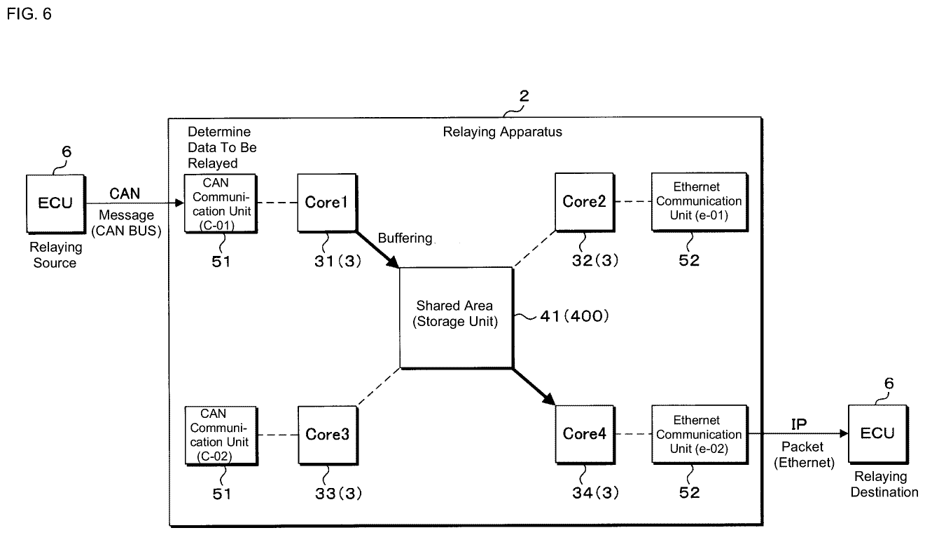

FIG. 6 is a diagram (logical configuration diagram) illustrating a relaying process of relay target data by the relaying apparatus 2. A corresponding internal communication unit 5 is set for each of the first control unit 31, the second control unit 32, the third control unit 33, and the fourth control unit 34 that constitutes the control unit 3.

The internal communication unit 5 corresponding to the first control unit 31 (“Core1”) is, for example, a CAN communication unit 51 with the communication unit number “C-01”. The internal communication unit 5 corresponding to the second control unit 32 (“Core2”) is, for example, the CAN communication unit 51 with the communication unit number “C-02”. The internal communication unit 5 corresponding to the third control unit 33 (“Core3”) is, for example, an Ethernet communication unit 52 with the communication unit number “e-01”. The internal communication unit 5 corresponding to the fourth control unit 34 (“Core4”) is, for example, the Ethernet communication unit 52 with the communication unit number “e-02”.

The first control unit 31 handles processing for receiving (acquiring) and transmitting (outputting) transmission data at the CAN communication unit 51 “C-01”. The second control unit 32 handles processing for receiving (acquiring) and transmitting (outputting) transmission data at the CAN communication unit 51 “C-02”. The third control unit 33 handles processing for receiving (acquiring) and transmitting (outputting) transmission data at the Ethernet communication unit 52 “e-01”. The fourth control unit 34 handles processing for receiving (acquiring) and transmitting (outputting) transmission data at the Ethernet communication unit 52 “e-02”.

The storage unit 4 includes the shared area 41 that can be accessed by

each of the first control unit 31, the second control unit 32, the third control unit 33, and the fourth control unit 34. When a control unit 3 that has completed the initialization process has acquired relay target data to be relayed via a communication unit corresponding to another control unit 3 that has not completed the initialization process, the shared area 41 is used as a storage area for buffering such relay target data.

In the example described in the present embodiment, the control unit 3 that has completed the initialization process is assumed to be the first control unit 31, and the other control unit 3 that has not completed the initialization process is assumed to be the fourth control unit 34. The first control unit 31 determines whether a CAN message (transmission data) received from the CAN communication unit 51 (C-01) controlled by the first control unit 31 is to be relayed. As one example, the first control unit 31 refers to the relaying route table and determines whether the CAN message is transmission data to be relayed (that is “relay target data”) to the fourth control unit 34.

If the CAN message is transmission data to be relayed (or “relay target data”) to the fourth control unit 34, and the fourth control unit 34 has not completed the initialization process, the first control unit 31 stores (buffers) that CAN message in the shared area 41. When buffering relay target data, such as a CAN message in the shared area 41, the first control unit 31 selects and buffers only part of the relay target data out of all of the received relay target data based on a predetermined rule that is set in advance. By doing so, it is possible to suppress or prevent the free space (free capacity) of the shared area 41 from running out or becoming tight.

After completing the initialization process, the fourth control unit 34 refers to the shared area 41 and obtains the CAN message (or “relay target data”) that was buffered by the first control unit 31 and generates an IP packet through protocol conversion of the CAN message to an IP packet. When a plurality of CAN messages including the same message ID have been buffered, the fourth control unit 34 may perform protocol conversion by including data included in the payloads of the plurality of CAN messages in the payload of a single IP packet.

The fourth control unit 34 transmits (outputs) the generated IP packet from the Ethernet communication unit 52 (e-02) it controls to the vehicle-mounted ECU 6 connected to that Ethernet communication unit 52 (e-02). Alternatively, the fourth control unit 34 may transmit (output) the generated IP packet using a multicast without specifying a vehicle-mounted ECU 6 as the transmission destination.

By performing buffering using the shared area 41 in this way, it is possible to perform a relaying process between a control unit 3 that has completed the initialization process (here, the first control unit 31) and another control unit 3 that has not completed the initialization process (here, the fourth control unit 34). By performing processing so that only some of the relay target data is buffered in the shared area 41, it is possible to suppress or prevent the free space in the shared area 41 from running out or becoming tight.

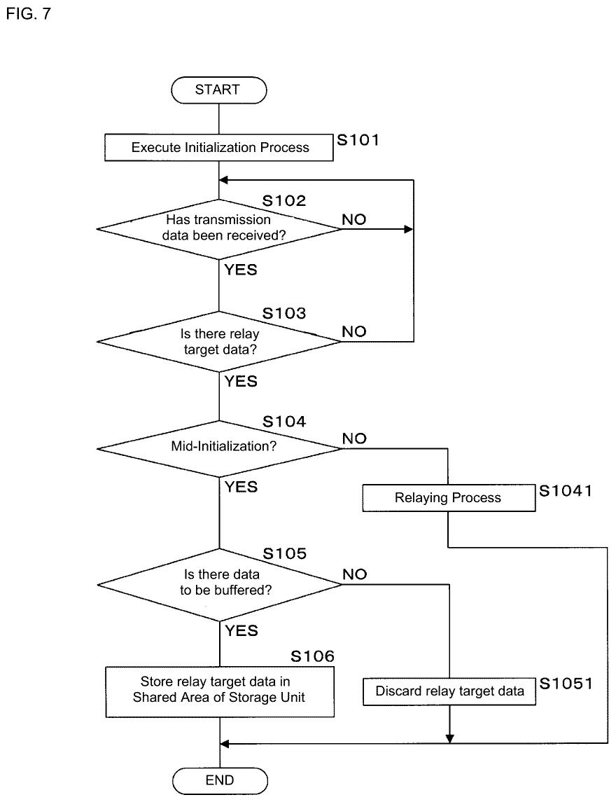

FIG. 7 is a flowchart depicting the processing of the control unit 3 of the relaying apparatus 2. The control unit 3 of the relaying apparatus 2 regularly performs the following processing, as one example, when the vehicle C is started (that is, when the ignition switch 8 is turned on). The control unit 3 of the relaying apparatus 2 is, for example, a multi-core CPU constituted of a plurality of cores or CPUs, and in the present embodiment, is composed of four cores (or control units 3) that are the first control unit 31, the second control unit 32, the third control unit 33, and the fourth control unit 34.

The first control unit 31, the second control unit 32, the third control unit 33, and the fourth control unit 34 sequentially perform the initialization process in a predetermined initialization order. A core (or “control unit 3”) that has completed the initialization process performs the following processing on cores (or “control units 3”) that have not completed the initialization process, that is, every core (control unit 3) that will complete the initialization process later than itself (the present core). In the example described in the present embodiment, the core (control unit 3) that has completed the initialization process is assumed to be the first control unit 31 (“Core1”) that completes the initialization process first, and the other core (control unit 3) that has not completed the initialization process is assumed to be the fourth control unit 34 (“Core4”) that completes the initialization process last.

The first control unit 31 (control unit 3) of the relaying apparatus 2 executes the initialization process (S101). As one example, the first control unit 31 of the relaying apparatus 2 obtains an on signal outputted from the ignition switch 8 and uses the on signal as a trigger to start the initialization process. The initialization process is performed for the predetermined required initialization time as indicated in the correspondence table for example, and after the required initialization time has elapsed, the initialization process ends (is complete). By doing so, the first control unit 31 of the relaying apparatus 2 becomes a control unit 3 that has completed the initialization process.

The first control unit 31 (control unit 3) of the relaying apparatus 2 determines whether transmission data has been received (S102). If transmission data has not been received (S102: NO), the first control unit 31 (control unit 3) of the relaying apparatus 2 performs a loop process to execute the processing from S102 again.

When transmission data has been received (S102: YES), the first control unit 31 (control unit 3) of the relaying apparatus 2 determines whether the received transmission data is relay target data for the fourth control unit 34 (S103). If the received transmission data is not relay target data for the fourth control unit 34 (S103: NO), the first control unit 31 (control unit 3) of the relaying apparatus 2 performs a loop process to execute the processing from S102 again.

If the received transmission data is relay target data for the fourth control unit 34 (S103: YES), the first control unit 31 (the control unit 3) of the relaying apparatus 2 determines whether the fourth control unit 34 (or “other control unit 3”) corresponding to the internal communication unit 5 that is the relaying destination of the relay target data is mid-initialization (S104). The first control unit 31 of the relaying apparatus 2 determines whether the fourth control unit 34 is mid-initialization, that is, whether the fourth control unit 34 has finished (completed) the initialization.

The fourth control unit 34 being mid-initialization means that the fourth control unit 34 has not finished (completed) the initialization, and also includes a case where the fourth control unit 34 has not started the initialization. The first control unit 31 may calculate the initialization completion point of the fourth control unit 34 based on its own initialization completion point (or “normal operation starting point”), and determine, based on whether the current time has passed the initialization completion point of the fourth control unit 34, whether the fourth control unit 34 has ended (completed) the initialization.

When calculating the initialization completion point of the fourth control unit 34, the first control unit 31 may refer for example to the correspondence table stored in the storage unit 4. The initialization completion point of the fourth control unit 34 can be calculated relative to the initialization completion point (or “normal operation starting point”) of the first control unit 31 by summing the required initialization times of the second control unit 32, the third control unit 33, and the fourth control unit 34 that perform initialization after the first control unit 31.

If it has been determined that initialization has been completed (that is, the first control unit 31 is not mid-initialization) (S104: NO), the first control unit 31 (control unit 3) of the relaying apparatus 2 performs a relaying process (or “normal processing”) (S1041). When the first control unit 31 of the relaying apparatus 2 has determined that initialization of the fourth control unit 34 has been completed, by performing inter-process communication with the process or thread being executed at the fourth control unit 34 for example, a relaying process (or “normal processing”) is performed by passing the acquired relay target data to the fourth control unit 34. When initialization of the fourth control unit 34 has ended and is complete, the buffering that is performed when the fourth control unit 34 is mid-initialization is unnecessary, and a relaying process, which is realized by the first control unit 31 that controls the CAN communication unit 51 and the fourth control unit 34 that controls the Ethernet communication unit 52 performing a linked process, is performed as normal processing of the relaying apparatus 2.

If it has been determined that the initialization has not ended (that is, the state is “mid-initialization”) (S104: YES), the first control unit 31 (control unit 3) of the relaying apparatus 2 determines whether the relay target data is to be buffered based on the priority of the relay target data (S105). If the fourth control unit 34 has not finished the initialization, the first control unit 31 of the relaying apparatus 2 determines whether to buffer the relay target data based on the priority of the relay target data for example by referring to the relaying route table stored in the storage unit 4. As one example, if the relay target data is a CAN message, the priority is determined in keeping with the message ID (CAN-ID) included in that CAN message, and in the present embodiment, CAN messages where the value of the message ID is less than or equal to a predetermined value are set as data to be buffered.

If it has been determined that the data is to be buffered (S105: YES), the first control unit 31 (control unit 3) of the relaying apparatus 2 stores (buffers) the relay target data in the shared area 41 of the storage unit 4 (S106). When it has been determined, by referring to the relaying route table for example, that relay target data is to be buffered, the first control unit 31 of the relaying apparatus 2 stores (or “buffers”) that relay target data in the shared area 41 of the storage unit 4. This shared area 41 is set as a storage area that can also be accessed from the fourth control unit 34, so that the fourth control unit 34 that has finished the initialization process can acquired the relay target data that was buffered by the first control unit 31 by referring to this storage area.

When it has been determined that the data is not to be buffered (S105: NO), the first control unit 31 (control unit 3) of the relaying apparatus 2 discards the relay target data (S1051). When it has been determined, by referring to the relaying route table for example, that the relay target data is not to be buffered, that is, when the relay target data has a low priority and does not require buffering, the first control unit 31 discards the relay target data. By doing so, it is possible to suppress or prevent the free space in the shared area 41, which is a storage area provided for buffering purposes, from becoming tight or insufficient, which would make it impossible to buffer relay target data that has a high priority.

After executing S106, S1061, or S1041, the first control unit 31 (the control unit 3) of the relaying apparatus 2 ends the series of processes in this flow. Alternatively, the first control unit 31 (control unit 3) of the relaying apparatus 2 may perform a loop process where the processing is executed from S102 again after executing S106, S1061, or S1041.

After completing the initialization process, the fourth control unit 34 (or “other control unit 3”) of the relaying apparatus 2 refers to the shared area 41 in the storage unit 4 and acquires the relay target data that was stored (buffered) in the shared area 41 by the first control unit 31. When the relay target data is a plurality of CAN messages and the internal communication unit 5 controlled by the fourth control unit 34 is the Ethernet communication unit 52, the fourth control unit 34 may perform a relaying process on the relay target data by converting the obtained plurality of CAN messages into a single IP packet and outputting this IP packet from the Ethernet communication unit 52 that the fourth control unit 34 controls.

Since the storage capacity of the payload in an IP packet is larger than the storage capacity of the payload in a CAN message, by converting the plurality of buffered CAN messages into a single IP packet in this way, it is possible to efficiently perform a relaying process on the relay target data. That is, due to the control units 3 (the first control unit 31 and the second control unit 32) that controls the CAN communication units 51 completing (ending) the initialization process earlier than the control units 3 (that third control unit 33 and the fourth control unit 34) that control the Ethernet communication units 52, it is possible to convert a plurality of CAN messages buffered in the shared area 41 into a single IP packet and relay this packet, which improves the throughput of the relaying process. In this way, in the relaying apparatus 2 that is configured so that the individual control units 3 (the first control unit 31, the second control unit 32, the third control unit 33, and the fourth control unit 34) sequentially complete the initialization process, it is possible to favorably apply the buffering process according to the present embodiment when a relaying process is performed by transmitting transmission data received by the CAN communication unit 51 from the Ethernet communication unit 52.

Although the fourth control unit 34 converts the plurality of CAN messages that were buffered by the first control unit 31 into a single IP packet in the present embodiment, the present disclosure is not limited to this. The first control unit 31 may convert a plurality of buffered CAN messages into a single IP packet. That is, it is also possible for the first control unit 31 to convert a plurality of CAN messages to be buffered into a single IP packet and store (buffer) the converted IP packet in the shared area 41. By doing so, after the initialization process is completed, the fourth control unit 34 can obtain the converted IP packet by referring to the shared area 41 and can output this IP packet from the Ethernet communication unit 52 it controls, which further improves the throughput of the relaying process.

In the flow described above, the first control unit 31 (Core1) that completes the initialization process first performs the same processing as the processing on the fourth control unit 34 (Core4) that completes the initialization process last for the second control unit 32 (Core2) and the third control unit 33 (Core3) which also perform the initialization process later than itself (the first control unit 31). The second control unit 32 and the third control unit 33 perform the same processing as the fourth control unit 34 on the relay target data that has been stored (buffered) in the shared area 41 by the first control unit 31.

The first control unit 31 (Core1) may perform processing on each core (that is, the second control unit 32, the third control unit 33, and the fourth control unit 34) that performs initialization process later than the first control unit 31 through parallel processing which for example uses a plurality of processes or threads. The first control unit 31 (Core1) may perform parallel processing by performing the processes from S101 to S103 for example commonly for the second control unit 32, the third control unit 33, and the fourth control unit 34 that perform the initialization process after the first control unit 31 and performing the processing from S104 onward individually for the second control unit 32, the third control unit 33, and the fourth control unit 34. When doing so, by performing the processing in S103, it is possible to specify which core (that is, which of the second control unit 32, the third control unit 33, and the fourth control unit 34) the relay target data (the relaying process) is for. This processing is not limited to the present embodiment, and may be performed in the same way in the other embodiments described later.

The second control unit 32 (Core2) performs the same processing as the flow described above performed by the first control unit 31 for the third control unit 33 (Core3) and the fourth control unit 34 (Core4), which perform the initialization process later than the second control unit 32 (Core2). The third control unit 33 (Core3) performs the same processing as the flow described above performed by the first control unit 31 for the fourth control unit 34 (Core4) which performs the initialization process later than the third control unit 33 (Core3). For the fourth control unit 34 (Core 4) which completes the initialization process last, it should be obvious that since there is no core (control unit 3) that completes the initialization process later than the fourth control unit 34, there is no need to perform processing according to the flow described above.

### Second Embodiment

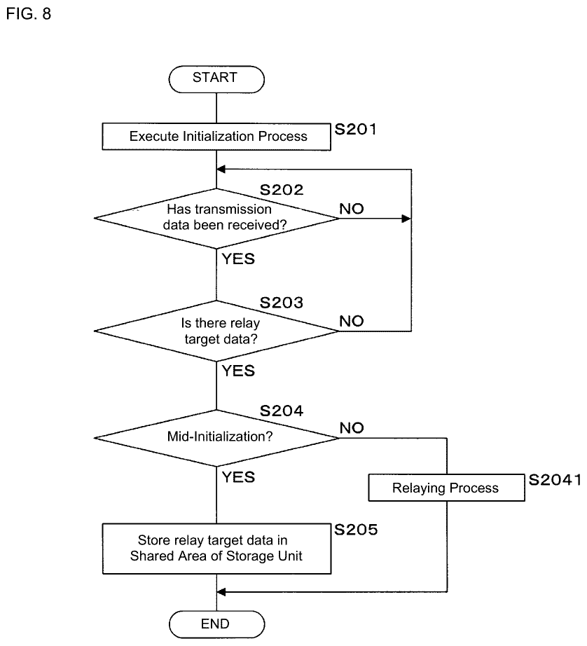

FIG. 8 is a flowchart depicting the processing of the control unit 3 of the relaying apparatus 2 according to a second embodiment (storage of most recent value). In the same way as the first embodiment, the control unit 3 of the relaying apparatus 2 regularly performs the following processing when, for example, the vehicle C is started (that is, when the ignition switch 8 is turned on).

The first control unit 31 (control unit 3) of the relaying apparatus 2 executes an initialization process (S201). The first control unit 31 (control unit 3) of the relaying apparatus 2 determines whether transmission data has been received (S202). The first control unit 31 (control unit 3) of the relaying apparatus 2 determines whether the received transmission data is relay target data for the fourth control unit 34 (S203). The first control unit 31 (control unit 3) of the relaying apparatus 2 determines whether the fourth control unit 34 (or “other control unit 3”) corresponding to the internal communication unit 5 that is the relaying destination of the relay target data is mid-initialization (S204). If it has been determined that initialization has been completed (S204: NO), the first control unit 31 (control unit 3) of the relaying apparatus 2 performs a relaying process (or “normal processing”) (S2041). The first control unit 31 of the relaying apparatus 2 performs the processing from S201 to S2041 in the same way as S101 to S1041 of the first embodiment.

If it has been determined that the initialization has not ended (S204: YES), the first control unit 31 (control unit 3) of the relaying apparatus 2 stores (buffers) the relay target data in the shared area 41 of the storage unit 4 (S205) by overwriting. The relay target data for the fourth control unit 34 is buffered in the shared area 41, with this relay target data being classified into a plurality of types. Regarding the types of relay target data, if, for example, the relay target data is a CAN message, the relay target data will be classified according to message ID (CAN-ID), so that CAN messages with the same message ID are relay target data of the same type and CAN messages with different message IDs are relay target data of different types.

Out of a plurality of relay target data that have been acquired, the first control unit 31 of the relaying apparatus 2 buffers only the most recent relay target data out of the same type of relay target data in the shared area 41. By doing so, older relay target data of the same type as the relay target data that is the most recent relay target data and was previously buffered is overwritten using the most recent relay target data. In this way, the first control unit 31 of the relaying apparatus 2 stores (buffers) only the most recent relay target data in the shared area 41 in keeping with the type of acquired (received) relay target data. Accordingly, when acquired (received) relay target data is to be buffered in the shared area 41, if relay target data of the same type as this relay target data (as one example, a CAN message with the same CAN-ID) has already been buffered, the relay target data that has already been buffered will be overwritten.

Although the first control unit 31 of the relaying apparatus 2 buffers only the latest relay target data out of each type of relay target data in the shared area 41, the present disclosure is not limited to this. The first control unit 31 of the relaying apparatus 2 may buffer two (that is, two generations of) relay target data composed of the latest data and the immediately preceding relay target data in the shared area 41. Alternatively, depending on the storage capacity of the shared area 41, multiple generations of relay target data including the latest data and two or more earlier generations of relay target data may be buffered in the shared area 41. Alternatively, the first control unit 31 of the relaying apparatus 2 may buffer two generations of relay target data classified as having high priority in keeping with the priorities used in the first embodiment and buffer one generation of relay target data classified as having low priority (that is, management of generations with lower priority than relay target data classified as high priority).

### Third Embodiment

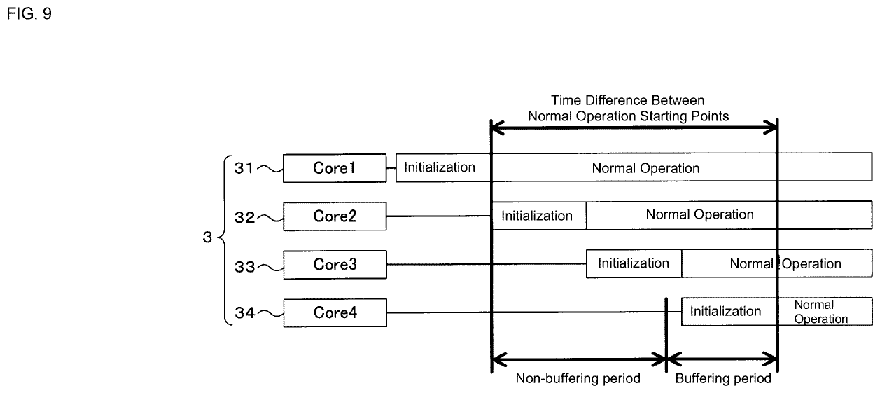

FIG. 9 is a diagram illustrating initialization process by a plurality of control units 3 according to a third embodiment (initialization completion imminent). Depending on the starting order of the initialization process, a time difference occurs between the normal operation starting points, and as one example, the time difference between the normal operation starting points of the first control unit 31 and the fourth control unit 34 is a time (period) produced by summing the required initialization times of the second control unit 32, the third control unit 33, and the fourth control unit 34. In this case, the period due to this time difference between the normal operation starting points is divided into a non-buffering period and a buffering period, and the first control unit 31 buffers only relay target data received during the buffering period in the shared area 41. Such buffering period may be defined separately for each of the first control unit 31, the second control unit 32, the third control unit 33, and the fourth control unit 34, which are the individual control units 3, with the respective buffering periods being stored for example in the storage unit 4.

The buffering period may be determined based on the transmission cycle of relay target data to be relayed to the fourth control unit 34. The buffering period for the fourth control unit 34 may be longer than or equal to transmission cycle of relay target data to be relayed to the fourth control unit 34, that is, relay target data to be relayed via the internal communication unit 5 (the Ethernet communication unit 52) corresponding to the fourth control unit 34.

If the relay target data includes a plurality of types of relay target data (such as a plurality of message IDs), the buffering period may be set loner than or equal to the longest transmission cycle out of the transmission cycles of the various types of relay target data. By setting a minimum value for the buffering period in this way, it will be possible, even when the relay target data includes a plurality of types of relay target data, to acquire each type of relay target data at least once and buffer the relay target data in the shared area 41.

In addition, the buffering period may be set to shorter than or equal to the sum of the transmission cycles of each type of relay target data. By setting a maximum value for the buffering period in this way, it is possible to prevent the buffering period from becoming excessively long and thereby prevent the total amount of the relay target data to be buffered from increasing excessively.

In the period caused by the time difference between normal operation starting points, the non-buffering period is placed in the first half and the buffering period is placed in the second half. By doing so, if the fourth control unit 34 is taken as an example, comparatively new relay target data, which includes the latest relay target data that has just been received, relative to the normal operation starting point of the fourth control unit 34 can be buffered in the shared area 41.

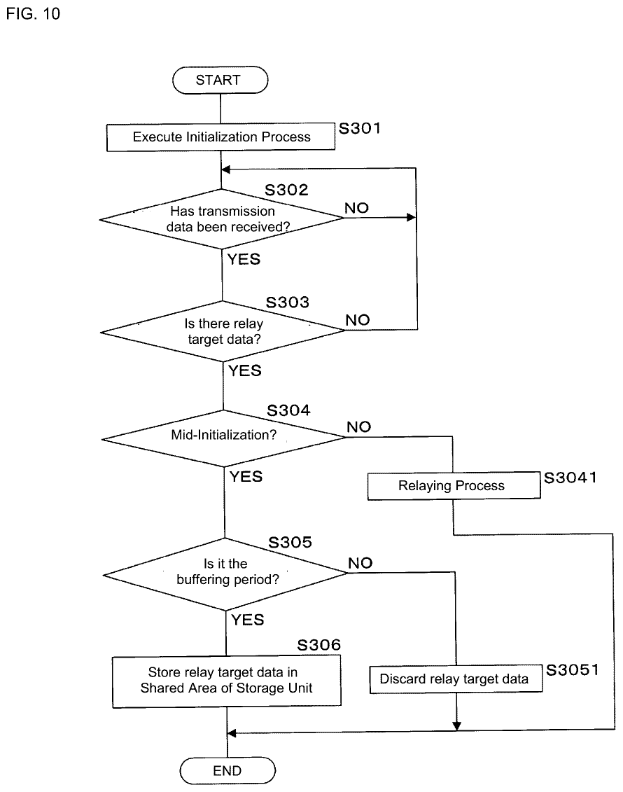

FIG. 10 is a flowchart depicting the processing of a control unit 3 of the relaying apparatus 2. In the same way as in the first embodiment, the control unit 3 of the relaying apparatus 2 regularly performs the following processing when, for example, the vehicle C is started (that is, when the ignition switch 8 is turned on). The first control unit 31 (control unit 3) of the relaying apparatus 2 executes an initialization process (S301). The first control unit 31 (control unit 3) of the relaying apparatus 2 determines whether transmission data has been received (S302). The first control unit 31 (control unit 3) of the relaying apparatus 2 determines whether the received transmission data is relay target data for the fourth control unit 34 (S303). The first control unit 31 (control unit 3) of the relaying apparatus 2 determines whether the fourth control unit 34 (or “other control unit 3”) corresponding to the internal communication unit 5 that is the relaying destination of the relay target data is mid-initialization (S304). If it has been determined that initialization has been completed (S304: NO), the first control unit 31 (control unit 3) of the relaying apparatus 2 performs a relaying process (or “normal processing”) (S3041). The first control unit 31 of the relaying apparatus 2 performs the processing from S301 to S3041 in the same way as S101 to S1041 in the first embodiment.

If it has been determined that the initialization has not completed (S304: YES), the first control unit 31 (control unit 3) of the relaying apparatus 2 determines whether it is the buffering period (S305). If the fourth control unit 34 has not completed the initialization, the first control unit 31 of the relaying apparatus 2 determines whether the current time is included in the buffering period of the fourth control unit 34. The buffering period of the fourth control unit 34 is specified through back calculation with a relaying process starting point of the fourth control unit 34 as a reference (that is, the end point of the buffering period). The buffering period is set as an appropriate period in keeping with the storage capacity of the shared area 41, and as one example is a period that is approximately 40% of the time difference between the normal processing (relaying process) starting points of the first control unit 31 and the fourth control unit 34.

Alternatively, the buffering period for the fourth control unit 34 may be set based on the transmission cycle of the relay target data to be relayed to the fourth control unit 34 (that is, the Ethernet communication unit 52: e-02), as one example, a value that is greater than or equal to the transmission cycle. If the relay target data includes a plurality of types of relay target data (CAN messages) such as a plurality of message IDs, the buffering period may be set so as to be longer than or equal to the longest transmission cycle out of the transmission cycles of the respective types of relay target data. By doing so, it will be possible to acquire every type of relay target data at least once and buffer the relay target data in the shared area 41.

The storage unit 4 stores the buffering periods of the fourth control unit 34 and the other control units 3 (that is, the second control unit 32 and the third control unit 33), and by referring to the storage unit 4, the first control unit 31 can specify the buffering period of a control unit such as the fourth control unit 34. In the same way as in the first embodiment, by referring to a correspondence table for example, the first control unit 31 calculates the initialization completion point (which is the normal operation starting point) of the fourth control unit 34 relative to the initialization completion point (that is, the “normal operation starting time”) of the first control unit 31. The first control unit 31 calculates the start point (time) and end point (time) of the buffering period of the fourth control unit 34 by back-calculating the buffering period of the fourth control unit 34 from the calculated initialization completion point (or “normal operation starting point”) of the fourth control unit 34. It should be obvious that the end time corresponds to (that is, matches) the initialization completion point (that is, the “normal operation starting point”) of the fourth control unit 34.

As one example, the first control unit 31 includes a clock function or the like, and if the current time is between the start time and end time of the buffering period of the fourth control unit 34, the first control unit 31 determines that the current time is in the buffering period of the fourth control unit 34. If the current time is not between the start time and the end time of the buffering period of the fourth control unit 34, or in other words, if the current time is earlier than the start time of the buffering period, the first control unit 31 determines that the current time is not in the buffering period for the fourth control unit 34 (and is in the “non-buffering period”).

If it has been determined that it is the buffering period (S305: YES), the first control unit 31 (control unit 3) of the relaying apparatus 2 stores (buffers) the relay target data in the shared area 41 of the storage unit 4 (S306). When it has been determined that it is the buffering period, that is, that the current time is included in the buffering period of the fourth control unit 34, the first control unit 31 of the relaying apparatus 2 stores (buffers) the relay target data in the shared area 41 of the storage unit 4 in the same way as in the process S106 in the first embodiment.

If it has been determined that it is not the buffering period (S305: NO), the first control unit 31 (control unit 3) of the relaying apparatus 2 discards the relay target data (S3051). If it has been determined that it is not the buffering period, that is, if the current time is not included in the buffering period of the fourth control unit 34, the first control unit 31 of the relaying apparatus 2 discards the relay target data in the same way as in the process S1061 in the first embodiment.

### Fourth Embodiment

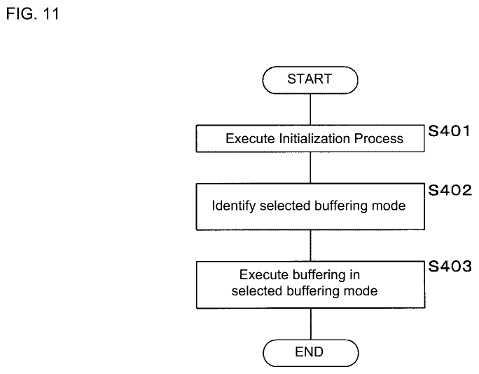

FIG. 11 is a flowchart depicting the processing of the control unit 3 of the relaying apparatus 2 according to the fourth embodiment (buffering mode selection). In the same way as in the first embodiment, the control unit 3 of the relaying apparatus 2 regularly performs the following processing, as one example, when the vehicle C is started (that is, when the ignition switch 8 is turned on).

The first control unit 31 (control unit 3) of the relaying apparatus 2 executes an initialization process (S401). The first control unit 31 of the relaying apparatus 2 performs the processing in S401 in the same way as S101 in the first embodiment.

The first control unit 31 (control unit 3) of the relaying apparatus 2 identifies the selected buffering mode (S402). The relaying apparatus 2 includes a plurality of buffering modes for specifying which relay target data is to be written for cases where only some of the acquired relay target data is to be written into the shared area 41. This plurality of buffering modes are based, for example, on the buffering processing in each of the embodiments described earlier. The plurality of buffering modes include, for example, “priority mode”, “most recent value mode”, and “initialization completion imminent mode”, and a flag value indicating the buffering mode that is currently selected is stored in the storage unit 4.

The first control unit 31 of the relaying apparatus 2 identifies the currently selected buffering mode for example by referring to the flag value stored in the storage unit 4. The buffering mode (flag value) may be selected (set) for example based on an input value inputted by an operator of the vehicle C in which the relaying apparatus 2 is mounted. Alternatively, the buffering mode (flag value) may be selected (set) based on a signal transmitted from the external server S1 which is operated and managed by the manufacturer of the vehicle C, for example. In this way, by allowing the buffering mode to be variably set, it is possible to perform buffering processing on the shared area 41 in an appropriate buffering mode for the vehicle C.

The first control unit 31 (control unit 3) of the relaying apparatus 2 performs buffering in the selected buffering mode (S403). The plurality of buffering modes include, for example, “priority mode”, “most recent value mode”, and “initialization completion imminent mode”.

When priority mode is selected, out of the acquired relay target data, the first control unit 31 of the relaying apparatus 2 writes relay target data with a predetermined priority or higher into the shared area 41. As one example, the processing by the first control unit 31 in the priority mode may be the processing from S102 to S106 of the first embodiment.

When most recent value mode is selected and the acquired relay target data includes a plurality of relay target data of the same type (for example, the same CANID), the first control unit 31 of the relaying apparatus 2 writes the most recent relay target data into the shared area 41 out of the plurality of relay target data of the same type. As one example, the processing of the first control unit 31 in latest value mode may be the processing in S202 to S205 of the second embodiment.

When initialization completion imminent mode is selected, the first control unit 31 of the relaying apparatus 2 writes the acquired relay target data into the shared area 41 during the buffering period specified by the relaying process starting point of the other control unit 3 whose initialization process is yet to end. As one example, the processing of the first control unit 31 in initialization completion imminent mode may be the processing in S302 to S306 of the third embodiment.

The number of selected buffering modes is not limited to one (a single mode), and a plurality of buffering modes may be selected. When two or more buffering modes are selected, the first control unit 31 of the relaying apparatus 2 may write some of the acquired relay target data into the shared area 41 according to a combination of the two or more selected buffering modes.

The embodiments disclosed above are exemplary in all respects and should not be regarded as limitations on the present disclosure. The scope of the present disclosure is indicated by the claims, not the description given above, and is intended to include all changes within the meaning and scope of the claims and their equivalents.

1. A relaying apparatus that is installed in a vehicle and relays data transmitted and received between a plurality of vehicle-mounted ECUs, the relaying apparatus comprising:
a plurality of communication units for communicating with each of the vehicle-mounted ECUs;
a plurality of control units that respectively correspond to the plurality of communication units; and
a storage unit that is accessible from each of the plurality of control units,
wherein each of the plurality of control units separately performs an initialization process, and
when a control unit that has completed the initialization process has acquired relay target data to be relayed via a communication unit corresponding to another control unit that has not completed the initialization process, the control unit stores part of the acquired relay target data in the storage unit by writing in a shared area that is shared with the other control unit that has not completed the initialization process.

2. The relaying apparatus according to claim 1, wherein out of the acquired relay target data, the control unit that has completed the initialization process writes relay target data with a predetermined priority or higher into the shared area.

3. The relaying apparatus according to claim 2,
wherein the relay target data is CAN messages, and
the control unit that has completed the initialization process specifies the priority of the relay target data in keeping with a CAN-ID included in the relay target data.

4. The relaying apparatus according to claim 1, wherein when the acquired plurality of pieces of relay target data include relay target data of a same type, the control unit that has completed the initialization process writes most recent relay target data, out of the relay target data of the same type, into the shared area.

5. The relaying apparatus according to claim 4,
wherein the relay target data is CAN messages, and
the control unit that has completed the initialization process determines whether relay target data is the same type based on a CAN-ID included in each relay target data.

6. The relaying apparatus according to claim 1, wherein the control unit that has completed the initialization process writes relay target data, which is acquired during a buffering period specified using an initialization process starting point of the other control unit that has not completed the initialization process, into the shared area.

7. The relaying apparatus according to claim 6, wherein the buffering period is determined based on a transmission cycle of the relay target data.

8. The relaying apparatus according to claim 1,
wherein the relaying apparatus is provided with a plurality of buffering modes for identifying the part of the acquired relay target data that is to be written into the shared area, and
the control unit that has completed the initialization process writes the part of the acquired relay target data into the shared area according to one or more buffering modes selected out of the plurality of buffering modes.

9. A program for causing a computer, which is installed in a vehicle, relays data transmitted and received between a plurality of vehicle-mounted ECUs, and is equipped with a plurality of communication units for communicating with each of the vehicle-mounted ECUs, a plurality of control units that one-to-one correspond to the plurality of communication units, and a storage unit that is accessible from each of the plurality of control units, to execute processing comprising:
each of the plurality of control units separately performing an initialization process; and
when a control unit that has completed the initialization process has acquired relay target data to be relayed via a communication unit corresponding to another control unit that has not completed the initialization process, the control unit storing part of the acquired relay target data in the storage unit by writing in a shared area that is shared with the other control unit that has not completed the initialization process.

10. A relaying method for causing a computer, which is installed in a vehicle, relays data transmitted and received between a plurality of vehicle-mounted ECUs, and is equipped with a plurality of communication units for communicating with each of the vehicle-mounted ECUs, a plurality of control units that one-to-one correspond to the plurality of communication units, and a storage unit that is accessible from each of the plurality of control units, to execute processing comprising:
each of the plurality of control units separately performing an initialization process; and
when a control unit that has completed the initialization process has acquired relay target data to be relayed via a communication unit corresponding to another control unit that has not completed the initialization process, the control unit storing part of the acquired relay target data in the storage unit by writing in a shared area that is shared with the other control unit that has not completed the initialization process.

11. The relaying apparatus according to claim 2,
wherein the relaying apparatus is provided with a plurality of buffering modes for identifying the part of the acquired relay target data that is to be written into the shared area, and
the control unit that has completed the initialization process writes the part of the acquired relay target data into the shared area according to one or more buffering modes selected out of the plurality of buffering modes.

12. The relaying apparatus according to claim 3,
wherein the relaying apparatus is provided with a plurality of buffering modes for identifying the part of the acquired relay target data that is to be written into the shared area, and
the control unit that has completed the initialization process writes the part of the acquired relay target data into the shared area according to one or more buffering modes selected out of the plurality of buffering modes.

13. The relaying apparatus according to claim 4,
wherein the relaying apparatus is provided with a plurality of buffering modes for identifying the part of the acquired relay target data that is to be written into the shared area, and
the control unit that has completed the initialization process writes the part of the acquired relay target data into the shared area according to one or more buffering modes selected out of the plurality of buffering modes.

14. The relaying apparatus according to claim 5,
wherein the relaying apparatus is provided with a plurality of buffering modes for identifying the part of the acquired relay target data that is to be written into the shared area, and
the control unit that has completed the initialization process writes the part of the acquired relay target data into the shared area according to one or more buffering modes selected out of the plurality of buffering modes.

15. The relaying apparatus according to claim 6,
wherein the relaying apparatus is provided with a plurality of buffering modes for identifying the part of the acquired relay target data that is to be written into the shared area, and
the control unit that has completed the initialization process writes the part of the acquired relay target data into the shared area according to one or more buffering modes selected out of the plurality of buffering modes.

16. The relaying apparatus according to claim 7,
wherein the relaying apparatus is provided with a plurality of buffering modes for identifying the part of the acquired relay target data that is to be written into the shared area, and
the control unit that has completed the initialization process writes the part of the acquired relay target data into the shared area according to one or more buffering modes selected out of the plurality of buffering modes.
